(19) United States
(12) Patent Application Publication
(10) Pub. No.: US 2014/0278560 A1
(43) Pub. Date: Sep. 18, 2014

(54) HEALTH INSURANCE PRODUCT

(71) Applicant: MSFS, LLC, Houston, TX (US)

(72) Inventors: Regina K. GOROG, Houston, TX (US); Elliott C. GOROG, Houston, TX (US); Garland LEVIT, Houston, TX (US); Donald N. LEVIT, Houston, TX (US)

(73) Assignee: MSFS, LLC, Houston, TX (US)

(21) Appl. No.: 13/799,358

(22) Filed: Mar. 13, 2013

(51) Int. Cl. G06Q 40/08

(52) U.S. Cl. CPC G06Q 40/08
USPC 705/4

(57) ABSTRACT

A health insurance product is provided for an insurance plan holder having a health insurance plan. For a first period, a periodic contribution payment for the health insurance plan is collected and aggregated as an insurance savings allocation balance of collected periodic contribution payments from the first period and at least a period immediately previous to the first period. A new periodic multiplier contribution for the first period is obtained by multiplying the periodic contribution payment for the first period by a variable multiplier that is variable for each period. A new cumulative multiplier contribution balance for the first period is determined, using a tangible computer processor, by adding the new periodic multiplier contribution obtained to a previous cumulative multiplier contribution balance determined for the period immediately previous to the first period.

### BACKGROUND

1. Field of the Disclosure

The present disclosure relates to the field of insurance products. More particularly, the present disclosure relates to providing a health insurance plan that, in some circumstances, increases coverage over time, allows reductions in payments after a target coverage amount is reached, and/or allows flexible periodic contributions which can result in reduced periodic payments.

2. Background Information

Adequate health insurance coverage can be difficult to obtain and, even when available, may not be meaningful enough to provide comprehensive and affordable coverage sought by those covered. Uninsured and underinsured individuals can then suffer from a lack of health care coverage, or impose additional costs and burdens on others, thereby harming the overall well-being of the health care system, when health care is sought without adequate health insurance.

### BRIEF DESCRIPTION OF THE DRAWINGS

FIG. 1 illustrates an exemplary computer system used to provide a health insurance product for an insurance plan holder, according to an aspect of the present disclosure;

FIG. 2 illustrates an exemplary network system used to provide a health insurance product for an insurance plan holder, according to an aspect of the present disclosure.

FIG. 3 illustrates a table showing exemplary inputs and factors for determining coverage amounts provided by insurance for an insurance plan holder, according to another aspect of the present disclosure.

FIG. 4 illustrates a flowchart showing an exemplary method for providing a health insurance product for an insurance plan holder, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

As described herein, a periodic contribution payment for a health insurance plan is collected and multiplied by a variable multiplier that is variable for each period. The result of the multiplication is described as a new periodic multiplier contribution, and can be used together with the periodic contribution payment to determine a paid up health insurance coverage for an insured party.

FIG. 1 illustrates exemplary computer system 100 used to provide a health insurance product for an insurance plan holder, according to an aspect of the present disclosure. The computer system 100 can include a set of instructions that can be executed to cause the computer system 100 to perform methods and functions disclosed herein. The computer system 100 may operate as a standalone device or may be connected, for example, using a network 199, to other computer systems or peripheral devices.

The computer system may operate in the capacity of a server computer or as a client computer in a server-client network environment, or as a peer computer system in a peer-to-peer (or distributed) network environment. The computer system 100 can also be implemented as or incorporated into various devices, such as a personal computer (PC), a laptop computer, a server computer, a client computer, a tablet computer (PC), a personal digital assistant (PDA), a mobile device, a smart phone, or any other machine capable of executing a set of instructions (sequential or otherwise) that specify actions to be taken by that machine. In a particular embodiment, the computer system 100 can be implemented using electronic devices that provide voice, video or data communication.

Further, while a single computer system 100 is illustrated, the term “system” shall also be taken to include any collection of systems or sub-systems that individually or jointly execute a set, or multiple sets, of instructions to perform one or more computer functions as described herein. Methods as described herein may be performed wholly or in part by or using one or more applications installed on and even downloaded to networked device with a processor and memory as described herein.

As illustrated in FIG. 1, the computer system 100 may include a processor 101, for example, a central processing unit (CPU), a graphics processing unit (GPU), or both. Moreover, the computer system 100 can include a random access memory (RAM) 102 and a read only memory (ROM) 103 that can communicate with each other via a bus 108. As shown, the computer system 100 may further include a visual user interface 105 that shows still or moving images, such as a liquid crystal display (LCD), an organic light emitting diode (OLED), a flat panel display, a solid state display, or a cathode ray tube (CRT). Additionally, the computer system 100 may include an alpha-numeric touch input device 106, such as a keyboard/virtual keyboard or touch-sensitive input screen, and a mouse 107. The computer system 100 can also include a drive unit 108, a signal generator 111, such as a speaker or remote control, and a receiver/transmitter 104.

In a particular embodiment, as depicted in FIG. 1, the drive unit 108 may include a computer-readable medium 109 in which one or more sets of instructions 110, e.g. software, can be embedded. A computer-readable medium 109 is a tangible article of manufacture, from which sets of instructions 110 can be read. Further, the instructions 110 may embody one or more of the methods or logic as described herein. In a particular embodiment, the instructions 110 may reside completely, or at least partially, within the random access memory 102, the read only memory 103, and/or within the processor 101 during execution by the computer system 100. The random access memory 102, the read only memory 103, and the processor 101 also may be or may include computer-readable media that are tangible and non-transitory during the time instructions 110 are stored therein.

The system 100 shown, described and envisioned in one or more devices in various embodiments can broadly include a variety of electronic and computer systems. In accordance with various embodiments of the present disclosure, the methods described herein may be implemented by software programs executable by a computer system. The software programs include executable instructions executed by processors as described herein. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 109 that includes instructions 110 or receives and executes instructions 110 responsive to a propagated signal so that a device connected to a network 199 can communicate voice, video or data over the network 199. Further, the instructions 110 may be transmitted or received over the network 199 via the receiver/transmitter 104. The computer-readable medium 109 or any other computer-readable medium contemplated herein may be a tangible machine or article of manufacture that is tangible and non-transitory for a period of time during which instructions and/or data are stored therein or thereon.

As described herein, an insurance premium may be the only cost necessarily imposed in order to obtain or maintain basic insurance coverage in some form. However, additional insurance coverage may be obtained by paying additional costs. For example, catastrophic insurance coverage may be optionally obtained to ensure insurance coverage for costs above a predetermined (so-called “catastrophic”) level, and reinsurance or “gap” insurance coverage may be optionally obtained to ensure insurance coverage for costs above the basic insurance coverage and less than the catastrophic insurance coverage.

Insurance costs charged to an insurance plan holder may also include administrative costs. However, the insurance coverage obtained with a periodic contribution payment and periodic multiplier contribution derived from the periodic contribution payment as described herein is not the basic coverage, reinsurance/gap coverage, or catastrophic coverage already known. Rather, the periodic contribution payment described herein is aggregated in an insurance savings allocation balance, and the periodic multiplier contribution derived from the periodic contribution payment is added to a cumulative multiplier contribution balance. These balances combine to provide a form of “cash” basis insurance coverage benefit, akin to a savings deposit account with interest accumulated at a rate that varies each period and that is applied to each periodic deposit. However, the balances described herein may be restricted for use to satisfy qualified medical expenses or for other particular specified forms of insurance expenses.

The insurance coverage obtained by the insurance savings allocation balance and cumulative multiplier contribution balance described herein is not basic coverage, reinsurance/gap coverage, or catastrophic coverage already known. The descriptions herein are primarily descriptions of periodic contribution payments allocated as an insurance savings allocation to an insurance savings allocation balance, and periodic multiplier contributions obtained based on the periodic contribution payments using a variable multiplier and added to a cumulative multiplier contribution balance. The periodic contribution payments and periodic multiplier contributions can then be worked into larger plans that include one or more of the additional components as described herein.

FIG. 2 illustrates an exemplary network system used to provide a health insurance product for an insurance plan holder, according to an aspect of the present disclosure. In FIG. 2, an insurance plan holder computer 201 and insurance plan holder smartphone 203 communicate over networks 210 with insurance agent computer 241 and insurance agent smartphone 243. The insurance plan holder computer 201, insurance plan holder smartphone 203, insurance agent computer 241 and insurance agent smartphone 243 are representative of computing and communications devices with a processor and memory. The methods described herein can be performed on, by or for one or more of the computers 201, 241 and smartphones 203, 243 described herein. The methods described herein may also be performed wholly or in part by server computers or other devices that are not shown, but which can execute logic to implement the methods to provide a health insurance product to an insurance plan holder as described herein. The networks 210 may be one or more of a wireless network and a wired network, one or more of a local area network and a wide area network, and may use any known protocols for wired and wireless communications that are compatible with the methods described herein.

FIG. 3 illustrates a table showing exemplary inputs and factors for determining coverage amounts provided by insurance paid for with periodic contribution payments described herein, according to an aspect of the present disclosure. In the embodiment of FIG. 3, the left column shows periods numbered from 1 to 45. The periods shown in FIG. 3 may be months, quarters, weeks or any other period consistent with the explanations herein. The second column shows, for periods 1 to 38, dollar contributions submitted by or on behalf of an insurance plan holder. The dollar contributions in the second column of FIG. 3 are the periodic contribution payments described herein, though the denominations and currency mediums may vary in different embodiments. The fifth column shows the sum of the periodic contribution payments for each period up to 45.

In FIG. 3, a variable multiplier (X) that can vary for each period is shown in column 3. In the embodiment of FIG. 3, the variable multiplier (X) increases for each period. As explained herein, the variable multiplier (X) would normally be expected to increase after periods for which a claim is not presented against the insurance plan by the insurance plan holder. If the variable multiplier (X) increases, the cumulative multiplier contribution calculated using the variable multiplier (X) increases. In this embodiment, if the multiplier (X) is increased and nothing else is changed, the “cash” basis insurance coverage benefit value will increase. However, the multiplier (X) could still increase for periods following presentation of a claim, and decrease or stay the same after periods for which a claim is not presented, as the presentation of a claim is not the sole factor in determining the value of the variable multiplier (X). The multiplier (X) for each period is multiplied by the periodic contribution payment for each period to obtain a new periodic multiplier contribution for each period as X input in column 4. The sixth column in FIG. 3 shows the cumulative multiplier contribution balance (sum of periodic multiplier contributions) for each period up to 45.

In FIG. 3, the seventh column shows the sum of the insurance savings allocation balance and the cumulative multiplier contribution balance for each period up to 45. The sum in the seventh column reflects the “cash” basis insurance coverage benefit provided by the disclosure herein. As shown in FIG. 3, a periodic contribution payment is collected for each period. The periodic contribution payment may be collected as cash, a check, an electronic deposit or payment, a credit card payment, or any other form of payment known. As described herein, the periodic contribution payment is for an insurance savings allocation balance, and is also used to obtain a periodic multiplier contribution, but is not payment to obtain basic coverage, reinsurance coverage, or catastrophic coverage.

For an exemplary “first period”, such as, e.g., period 5 in FIG. 3, $266.67 is collected for a total of $1333.35 collected in periods 1 to 5. The periodic contribution payment is collected from or on behalf of the insurance plan holder for the health insurance plan, and is aggregated as an insurance savings allocation balance of periodic contribution payments to date. As explained herein, however, an insurance savings allocation balance may also be reduced by the amounts of payments for claims against the health insurance plan. The insurance savings allocation balance is a form of medical “cash” basis insurance coverage benefit value, analogous to a medical savings account, and the cumulative multiplier contribution is also a form of medical “cash” basis insurance coverage benefit value, analogous to interest on the periodic contribution payments. In the examples described herein, an insurance product is mainly described for health insurance, and payments from the insurance savings allocation balance may be restricted to qualified medical expenses. However, the concepts described herein may be applied to other forms of insurance, and payments from such other forms of insurance may be restricted to appropriate claims covered by the other forms of insurance.

Claims against the insurance savings allocation balance and cumulative multiplier contribution balance described herein are typically paid first from the insurance savings allocation balance and second from the cumulative multiplier contribution balance. However, claims may be paid first from the cumulative multiplier contribution balance and second from the insurance savings allocation balance in some embodiments. After a claim is paid from one or both balances, a periodic contribution payment in the next period is multiplied by the multiplier for the next period and added to what remains from the previous periodic multiplier contribution balance to obtain a new periodic multiplier contribution balance.

The new periodic multiplier contribution for each period is obtained by multiplying the insurance savings allocation balance through the period by a multiplier specific to the period as shown in the third column. In FIG. 3, the multiplier is expected typically to increase for each successive period for which a claim is not made by the insurance plan holder. A new cumulative multiplier contribution balance shown in FIG. 3 is calculated for each period by adding the new periodic multiplier contribution in the fourth column obtained for the period to a previous cumulative multiplier contribution balance in the sixth column calculated for the period immediately previous to the period.

Payments for claims are typically distributed for claims against the health insurance plan first from the insurance savings allocation balance shown in the fifth column until the insurance savings allocation balance is depleted or the claim is satisfied, and second from the new cumulative multiplier contribution balance shown in the sixth column until the new cumulative multiplier contribution balance is depleted, an additional periodic contribution payment is made or the claim is satisfied. However, payments for claims may be paid first from the cumulative multiplier contribution balance and second from the insurance savings allocation balance.

In the table of FIG. 3, the multiplier (X) may be reduced for a subsequent period after a claim is made by the insurance plan holder. On the other hand, periodic contribution payments are waived at period 39 (and reduced in period 38) once the sum of the insurance savings allocation balance and the new cumulative multiplier contribution balance shown in the seventh column reaches a threshold of $25000.5679. The collection of periodic contribution payments is then reinstated once a payment for a claim is made and the sum of the insurance savings allocation balance and the new cumulative multiplier contribution balance shown in the seventh column falls below the threshold.

The threshold is not an absolute requirement in the disclosure herein, as an insurance plan holder may wish to continually increase the medical “cash” insurance coverage benefit value of the insurance savings allocation balance and cumulative multiplier contribution balance so as to reduce or eliminate the need for payments for, e.g., catastrophic coverage. Similarly, the concepts of waiving and reinstating periodic contribution payments are also optional and, when used, are not necessarily based solely on reaching a threshold or depleting one or both balances. In some circumstances, no threshold is set. For example, a plan holder may wish to continue growing the insurance savings allocation balance and cumulative multiplier contribution balance so as to reduce or eliminate the need for catastrophic coverage. Therefore, thresholds, waiving periodic contribution payments, and reinstating periodic contribution payments may be optional for a plan holder in one or more embodiments.

In FIG. 3, a residual amount from the new cumulative multiplier contribution balance remains available for payment of a second claim after a payment for a first claim is made so long as the payment for the first claim does not deplete the entirety of the sum of the insurance savings allocation balance and the new cumulative multiplier contribution balance shown in the seventh column. Thus, the medical “cash” insurance coverage value shown in the seventh column is the medical “cash” insurance coverage benefit amount for the health insurance product described herein for each period, and will increase with each periodic contribution payment until the target threshold, if any, is reached and periodic contribution payments stop, or unless a claim is filed and the medical “cash” insurance coverage decreases due to the claim. Therefore, this medical “cash” insurance coverage value may be considered a total “paid up” medical “cash” insurance coverage benefit.

In FIG. 3, a residual amount from the insurance savings allocation balance in the fifth column for a period remains available for payment of a second claim after a payment for a first claim is made so long as the payment for the first claim does not exceed the insurance savings allocation balance in the fifth column. As noted above, claims are normally paid first from the insurance savings allocation balance, but this is not always necessarily the case.

The new cumulative multiplier contribution balance for a period is obtained by adding the result of multiplying the variable multiplier in the third column for the period with the periodic contribution payment in the second column for the period, with the result of multiplying each multiplier in the third column for previous periods with the periodic contribution payments in the third column for the previous periods respectively, and subtracting any payments for claims made and taken from the cumulative multiplier contribution balances in the period or previous periods. The insurance savings allocation balance in the firth period is obtained by subtracting any payments for claims made in the period and previously from the collected periodic contribution payments from the period and previously.

A medical “cash” value insurance coverage amount for each period is determined by adding the new cumulative multiplier contribution balance in the sixth column with the insurance savings allocation balance in the fifth column. The medical “cash” value insurance coverage amount varies for each period in the manner shown, and until the target “cash” value insurance coverage amount is reached in period 38. As shown, the insurance coverage amount normally increases for each successive period for which a claim is not made by the insurance plan holder, and typically continues to increase until the insurance coverage amount reaches a target insurance coverage amount threshold if any.

Periodic contribution payments are waived after period 38 once the target insurance coverage amount threshold of about $25000 is reached, until a payment for a claim is made and the sum of the insurance savings allocation balance and the new cumulative multiplier contribution balance falls below the target insurance coverage amount threshold. However, as noted above, the concepts of thresholds (target coverage amounts), waivers, and reinstatements are optional features of the present disclosure.

FIG. 4 illustrates a flowchart showing an exemplary method for providing a health insurance product for an insurance plan holder, according to an aspect of the present disclosure. In FIG. 4, a periodic contribution payment for a period is collected at S400. A variable multiplier for the period is determined at S405, and a periodic multiplier contribution for the period is calculated at S410. At S420, a cumulative insurance savings allocation balance is calculated, and at S425 a cumulative multiplier contribution balance is calculated to obtain a total “paid up” “cash” value insurance coverage. At S430, a sum of the cumulative insurance savings allocation balance and cumulative multiplier contribution balance is calculated. At S435, a determination is made as whether a claim is to be paid. If a claim is to be paid, at S445 the insurance savings allocation balance is depleted first, and if no claim is to be paid the process moves to the next period at S440 and returns to S400. After depleting the insurance savings allocation balance at S445, a determination at S450 is made as to whether the claim is satisfied. If the claim is satisfied at S450, the process moved to the next period at S440 and returns to S400. If the claim is not satisfied at S450, at S455 the multiplier contribution balance is depleted second and afterwards the process moves to the next period at S440 and returns to S400.

Payments may be received by an insurance provider or by a proxy at S400, where the proxy is a bank or independent bill collection system. The insurance provider is notified of receipt of the contribution for the period, and the received contribution is identified and associated with the insurance plan that includes the medical “cash” value insurance coverage.

For example, an individual signs up for a health insurance plan with an insurer. The individual agrees to contribute a fixed amount under the arrangement shown in FIG. 3 or a similar arrangement, until a target coverage threshold is reached at period 38. The initial periodic contribution payment of $266.67 per period is determined, and the periodic contribution payment will be supplemented with the periodic multiplier contribution, and both will be considered part of the “paid up” medical “cash” value insurance coverage shown in the seventh column. Of note, once the fixed coverage threshold if reached, the insured will remain insured via the “paid up” medical “cash” value insurance coverage, though no additional contributions towards the insurance savings allocation balance are collected.

As described, the insurance coverage amount shown in the seventh column of FIG. 3 is determined based on the inputs of the insurance savings allocations shown in the fifth column of FIG. 3, and the variable multipliers shown in the third column of FIG. 3. The “paid up” insurance coverage shown in the seventh column in FIG. 3 is calculated by adding the balances in the fifth and sixth columns in FIG. 3. The multiplier reflects risk factors for an insurance plan holder, as well as whether and when (how long ago) claims have been filed by the insurance plan holder. The multiplier may also reflect, e.g., the insurer's financials, reserves, expected claims, expected surrenders of existing plans within a group, expected earnings on accounts, expected new customers purchasing and entering into new plans in the group, customers exiting plans in the group and various other actuarial means.

As illustrated, for every predetermined time period for which a periodic contribution payment is made, the insured's insurance coverage shown in the seventh column of FIG. 3 grows so long as no claim is made. When a claim has been received by the system 100, the amount of the insurance savings allocation balance is decreased, and the insurance coverage amount decreases by the same amount. Additionally, in the next period the multiplier in the third column of FIG. 3 returns to a lower value, and generally is expected to increase over time for so long as another claim is not received. Thus, when a claim has been received, the “cash” value insurance coverage amount is reduced due to the claim.

For example, assume the insurance savings allocation balance has reached $10048.49 at period 38, and a claim of $4,000 is received. The amount of funds in the insurance savings allocation balance is decreased by $4000.00, and the next period a periodic contribution payment of 266.67 would again be collected in order to begin building the paid up insurance coverage back up to the target of approximately $25000. However, the multiplier resets lower to 0.08 as in period 1, and the variable X in the fourth column of FIG. 3 will again only increase slowly in this example as the multiplier in the third column of FIG. 3 increases over time from 0.08. Notably, however, even when the variable multiplier is reduced, it does not have to be reduced to a particular predetermined number from a particular earlier period.

The received periodic contribution payment amount shown in the second column is identified as a “cash” value contribution to the insurance savings allocation balance. The periodic contribution payment amount is distributed to the “cash” value account (from the periodic contribution payments) shown in the fifth column of FIG. 3, and used to obtain a new cumulative multiplier contribution balance (sixth column) reflecting the multiplier X input in the account shown in the third column of FIG. 3 multiplied by the periodic contribution payment shown in the second column.

As noted already, the cost of insurance may reflect a variety of factors including, but not limited to, a premium for basic insurance, an amount of coverage built through “cash” value contributions, a cost of reinsurance, a cost of a coverage factor (a multiple of coverage) offered for a plan, a cost for a catastrophic health insurance plan (e.g., a high deductible health insurance plan) to complement the plan and any insurance administrative costs charged by the insurer including maintenance fees, administrative fees, charges for vendor and agent commissions to be paid out, etc.

As described, the insurance savings allocation and periodic multiplier contribution may be considered separate from the insurance premium portion, reinsurance portion, and catastrophic coverage portion. The insurance premium portion is the only required cost of an insurance policy, and any payment amount may vary for any given period. The insurance savings allocation and periodic multiplier contribution described herein are optional, along with any reinsurance portion and any catastrophic coverage. The insurance savings allocation and periodic multiplier contribution can be considered a medical “cash” value having characteristics of an investment, and the investment aspect of the medical “cash” value is retained by the insurance plan holder even after periodic contribution payments end. However, premium payments would still be required. A target threshold for an insurance savings allocation balance can be determined on a recurring basis by an insurance provider, the insured, or both.

An overall insurance payment may include an insurance premium payment for basic insurance coverage, as well as payments for reinsurance/gap coverage and for catastrophic coverage. Insurance charges for the reinsurance/gap coverage and catastrophic coverage may be based on assessed risks for a community or group, and the insurance charges may be assessed on a pay as you go basis. Pay as you go insurance is not analogous to the “paid up” insurance described herein, in that premium payments for pay as you go insurance provide coverage for only a period of time defined in the insurance contract that provides the pay as you go insurance. An overall insurance payment that includes these insurance charges in addition to the periodic contribution payment may also include payments for administrative costs.

As mentioned initially in this disclosure, the only “required” component of an insurance plan is the insurance premium for basic coverage. However, the focus of the present application involves the periodic contribution payment for the insurance savings allocation balance, and the derived periodic multiplier contribution for the cumulative multiplier contribution balance.

The insurance “paid up” coverage amount may be determined based on an amount of funds present in the two balances in the account. That is, the insurance “paid up” coverage amount at any time may be calculated by taking the insurance savings allocation balance and adding it to the cumulative multiplier contribution balance.

The insurance product described herein is designed so that the insurance company retains contributions except of paid claims. However, as illustrated, every predetermined time period (e.g., every premium payment cycle) that passes (and so long as no claim is made) the insured's insurance coverage grows.

When a claim is received, the “cash” value decreases and the total “paid up” insurance coverage amount is updated. The amount decrease of funds in the “cash” value account is based on the claim amount. Funds for claims are first deducted from the insured's insurance savings allocation balance until that is exhausted with the remaining balance then being deducted from the cumulative multiplier contribution balance.

As an example, if the insured has $11,500 in the insurance savings allocation balance, and $38,500 in the cumulative multiplier contribution balance, the insured has a resulting $50,000 of “paid up” coverage. In this example, $50,000 is a defined threshold for the “paid up” coverage. If there is then a $4,000 claim, the insurance savings allocation balance has more than enough funds to cover the claim so the result would be $7,500 remaining in the insurance savings allocation balance (i.e., the original $11,500 minus the $4,000 claim). The cumulative multiplier contribution balance would remain untouched at $38,500, leaving the insured with $46,000 of total “paid up” coverage remaining. However, once a claim is filed, the variable multiplier changes, typically by decreasing, in the subsequent period instead of increasing, and the insured's contributions going forward will apply towards again reaching the $50,000 of “paid up” coverage.

Of course, an account manager can also be alerted to receive, approve or disapprove, or otherwise review, proposed updates to the health insurance plan. For example, an account manager may be alerted to review any proposed reduction in a variable multiplier at any time, or after a claim is presented in any payment cycle. An account manager may also be alerted to review when a threshold, if any, is reached for the “cash” value insurance coverage.

The examples herein are merely provided for purposes of enhancing understanding of the present disclosure, and should not be considered as limiting. Those having ordinary skill in the art would readily understand that these examples may be extended and that other examples may be substituted for the ones disclosed.

According to an aspect of the present disclosure, a method of providing a health insurance product is provided for an insurance plan holder having a health insurance plan. The method involves determining a coverage amount, and includes, for a first period, collecting a periodic contribution payment for the health insurance plan and aggregating the periodic contribution payment collected as an insurance savings allocation balance of collected periodic contribution payments from the first period and at least a period immediately previous to the first period. A new periodic multiplier contribution for the first period is obtained by multiplying the periodic contribution payment for the first period by a variable multiplier that is variable for each period. A tangible computer processor is used to determine a new cumulative multiplier contribution balance for the first period by adding the new periodic multiplier contribution obtained to a previous cumulative multiplier contribution balance determined for the period immediately previous to the first period. The insurance savings allocation balance and the new cumulative multiplier contribution balance combined reflect a coverage amount for the insurance plan holder.

According to another aspect of the present application, the variable multiplier is not reduced for a second period subsequent to the first period when a claim is made for the first period.

According to yet another aspect of the present application, periodic contribution payments are waived once a sum of the insurance savings allocation balance and the new cumulative multiplier contribution balance reaches a threshold.

According to still another aspect of the present application, the method further includes reinstating the collection of periodic contribution payments once a payment for a claim is made and the sum of the insurance savings allocation balance and the new cumulative multiplier contribution balance falls below the threshold.

According to another aspect of the present application, a residual amount from the new cumulative multiplier contribution balance remains available for payment of a second claim after a payment for a first claim is made so long as the payment for the first claim does not exceed the sum of the insurance savings allocation balance and the new cumulative multiplier contribution balance.

According to yet another aspect of the present application, a residual amount from the insurance savings allocation balance remains available for payment of a second claim after a payment for a first claim is made so long as the payment for the first claim does not exceed the insurance savings allocation balance.

According to another aspect of the present application, the new cumulative multiplier contribution balance for the first period is obtained by adding the result of multiplying the multiplier for the first period with the periodic contribution payment for the first period, with the result of multiplying each multiplier for previous periods with the periodic contribution payments for the previous periods respectively, and subtracting any payments for claims made in the first period and previous periods and taken from any previous or new cumulative multiplier contribution balance.

According to another aspect of the present application, the insurance savings allocation balance is obtained by subtracting any payments for claims made in the first period and periods previous to the first period from the collected periodic contribution payments from the first period and periods previous to the first period.

According to yet another aspect of the present application, after a claim is made in a period, a remaining balance of the collected periodic contribution payments is carried over to a subsequent period, and a periodic contribution payment for the subsequent period is multiplied by the variable multiplier for the subsequent period to obtain a new periodic multiplier contribution balance for the subsequent period.

According to still another aspect of the present application, the method further includes determining a total, “paid up” insurance coverage amount for the first period by adding the new cumulative multiplier contribution balance for the first period and the insurance savings allocation balance.

According to another aspect of the present application, the “paid up” insurance coverage amount increases for each successive period for which a claim is not made, until the “paid up” insurance coverage amount reaches an insurance coverage amount threshold.

According to yet another aspect of the present application, periodic contribution payments are waived once the insurance coverage amount threshold is reached, until a payment for a claim is made and the sum of the insurance savings allocation balance and the new cumulative multiplier contribution balance falls below the insurance coverage amount threshold.

According to still another aspect of the present application, the method further includes, for the first period, collecting an insurance premium contribution with the periodic contribution payment, separating the insurance premium contribution from the periodic contribution payment, and aggregating the insurance premium contribution as an insurance premium value of collected insurance premium contributions from the first period and at least the period immediately previous to the first period.

According to another aspect of the present application, the insurance premium contribution includes payments for at least one of administrative charges and insurance charges.

According to yet another aspect of the present application, the insurance charges are based on assessed risks for one of a community and a group.

According to still another aspect of the present application, a payment for a claim made against the health insurance plan is distributed first from the insurance savings allocation balance until the insurance savings allocation balance is depleted or the claim is satisfied and second from the new cumulative multiplier contribution balance until the new cumulative multiplier contribution balance is depleted, an additional insurance savings allocation is added to the insurance savings allocation balance, or the claim is satisfied

According to another aspect of the present application, the insurance charges include charges that are assessed on a pay as you go basis.

According to yet another aspect of the present application, the variable multiplier increases for each successive period for which a claim is not made.

According to an aspect of the present disclosure, a system provides a health insurance product for an insurance plan holder having a health insurance plan. The system includes a memory that stores executable instructions and a processor that executes the executable instructions. When executed by the processor, the executable instructions cause the system to collect, for a first period, a periodic contribution payment for the health insurance plan and aggregate the periodic contribution payment collected as an insurance savings allocation balance of collected periodic contribution payments from the first period and at least a period immediately previous to the first period. When executed by the processor, the executable instructions cause the system to obtain a new periodic multiplier contribution for the first period by multiplying the periodic contribution payment for the first period by a variable multiplier that is variable for each period. When executed by the processor, the executable instructions also cause the system to determine, using a tangible computer processor, a new cumulative multiplier contribution balance for the first period by adding the new periodic multiplier contribution obtained to a previous cumulative multiplier contribution balance determined for the period immediately previous to the first period.

According to an aspect of the present disclosure, at least one non-transitory tangible computer readable storage medium stores executable instructions for providing a health insurance product for an insurance plan holder having a health insurance plan. The executable instructions, when executed by a tangible computer processor, cause a computer to collect, for a first period, a periodic contribution payment for the health insurance plan and aggregate the periodic contribution payment collected as an insurance savings allocation balance of collected periodic contribution payments from the first period and at least a period immediately previous to the first period. The executable instructions, when executed by a tangible computer processor, also cause a computer to obtain a new periodic multiplier contribution for the first period by multiplying the periodic contribution payment for the first period by a variable multiplier that is variable for each period. The executable instructions, when executed by a tangible computer processor, also cause a computer to determine a new cumulative multiplier contribution balance for the first period by adding the new periodic multiplier contribution obtained to a previous cumulative multiplier contribution balance determined for the period immediately previous to the first period.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the Figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method of providing a health insurance product for an insurance plan holder having a health insurance plan, the method comprising:
for a first period, collecting a periodic contribution payment for the health insurance plan and aggregating the periodic contribution payment collected as an insurance savings allocation balance of collected periodic contribution payments from the first period and at least a period immediately previous to the first period;
obtaining a new periodic multiplier contribution for the first period by multiplying the periodic contribution payment for the first period by a variable multiplier that is variable for each period, and
determining, using a tangible computer processor, a new cumulative multiplier contribution balance for the first period by adding the new periodic multiplier contribution obtained to a previous cumulative multiplier contribution balance determined for the period immediately previous to the first period.

2. The method of claim 1,
wherein the variable multiplier is not reduced for a second period subsequent to the first period when a claim is made for the first period.

3. The method of claim 1, further comprising:
waiving periodic contribution payments once a sum of the insurance savings allocation balance and the new cumulative multiplier contribution balance reaches a threshold.

4. The method of claim 3, further comprising:
reinstating the collection of periodic contribution payments once a payment for a claim is made and the sum of the insurance savings allocation balance and the new cumulative multiplier contribution balance falls below the threshold.

5. The method of claim 3,
wherein a residual amount from the new cumulative multiplier contribution balance remains available for payment of a second claim after a payment for a first claim is made so long as the payment for the first claim does not exceed the sum of the insurance savings allocation balance and the new cumulative multiplier contribution balance.

6. The method of claim 3,
wherein a residual amount from the insurance savings allocation balance remains available for payment of a second claim after a payment for a first claim is made so long as the payment for the first claim does not exceed the insurance savings allocation balance.

7. The method of claim 1,
wherein the new cumulative multiplier contribution balance for the first period is obtained by adding the result of multiplying the multiplier for the first period with the periodic contribution payment for the first period, with the result of multiplying each multiplier for previous periods with the periodic contribution payments for the previous periods respectively, and subtracting any payments for claims made in the first period and previous periods and taken from any previous or new cumulative multiplier contribution balance.

8. The method of claim 1,
wherein the insurance savings allocation balance is obtained by subtracting any payments for claims made in the first period and periods previous to the first period from the collected periodic contribution payments from the first period and periods previous to the first period.

9. The method of claim 8,
wherein, after a claim is made in a period, a remaining balance of the collected periodic contribution payments is carried over to a subsequent period, and a periodic contribution payment for the subsequent period is multiplied by the variable multiplier for the subsequent period to obtain a new periodic multiplier contribution balance for the subsequent period.

10. The method of claim 1, further comprising:
determining a total, paid up insurance coverage amount for the first period by adding the new cumulative multiplier contribution balance for the first period and the insurance savings allocation balance.

11. The method of claim 10,
wherein the paid up insurance coverage amount increases for each successive period for which a claim is not made, until the paid up insurance coverage amount reaches an insurance coverage amount threshold.

12. The method of claim 11, wherein periodic contribution payments are waived once the insurance coverage amount threshold is reached, until a payment for a claim is made and the sum of the insurance savings allocation balance and the new cumulative multiplier contribution balance falls below the insurance coverage amount threshold.

13. The method of claim 1, further comprising:
for the first period, collecting an insurance premium contribution with the periodic contribution payment, and separating the insurance premium contribution from the periodic contribution payment.

14. The method of claim 13, wherein the insurance premium contribution includes payments for at least one of administrative charges and insurance charges.

15. The method of claim 14, wherein the insurance charges are based on assessed risks for one of a community and a group.

16. The method of claim 1,
wherein a payment for a claim made against the health insurance plan is distributed first from the insurance savings allocation balance until the insurance savings allocation balance is depleted or the claim is satisfied and second from the new cumulative multiplier contribution balance until the new cumulative multiplier contribution balance is depleted, an additional insurance savings allocation is added to the insurance savings allocation balance, or the claim is satisfied.

17. The method of claim 14, wherein the insurance charges include charges that are assessed on a pay as you go basis.

18. The method of claim 1, wherein the variable multiplier increases for each successive period for which a claim is not made.

19. A system for providing a health insurance product for an insurance plan holder having a health insurance plan, the system comprising:
a memory that stores executable instructions; and
a processor that executes the executable instructions,
wherein, when executed by the processor, the executable instructions cause the system to:
collect, for a first period, a periodic contribution payment for the health insurance plan and aggregate the periodic contribution payment collected as an insurance savings allocation balance of collected periodic contribution payments from the first period and at least a period immediately previous to the first period;
obtain a new periodic multiplier contribution for the first period by multiplying the periodic contribution payment for the first period by a variable multiplier that is variable for each period, and
determine, using a tangible computer processor, a new cumulative multiplier contribution balance for the first period by adding the new periodic multiplier contribution obtained to a previous cumulative multiplier contribution balance determined for the period immediately previous to the first period.

20. At least one non-transitory tangible computer readable storage medium that stores executable instructions for providing a health insurance product for an insurance plan holder having a health insurance plan, the executable instructions, when executed by a tangible computer processor, causing a computer to:
collect, for a first period, a periodic contribution payment for the health insurance plan and aggregate the periodic contribution payment collected as an insurance savings allocation balance of collected periodic contribution payments from the first period and at least a period immediately previous to the first period;
obtain a new periodic multiplier contribution for the first period by multiplying the periodic contribution payment for the first period by a variable multiplier that is variable for each period, and
determine, using the tangible computer processor, a new cumulative multiplier contribution balance for the first period by adding the new periodic multiplier contribution obtained to a previous cumulative multiplier contribution balance determined for the period immediately previous to the first period.
